(19) United States
(12) Patent Application Publication
(10) Pub. No.: US 2024/0005410 A1
(43) Pub. Date: Jan. 4, 2024

(54) Systems and Methods for Verifying Insurance Policies

(71) Applicant: CSAA Insurance Services, Inc., Walnut Creek, CA (US)

(72) Inventors: Chandan Mishra, Walnut Creek, CA (US); Vikram Ravindhran, Walnut Creek, CA (US); Kelly Lau, Walnut Creek, CA (US); Olga Dotter, Walnut Creek, CA (US); Beti Cung, Walnut Creek, CA (US)

(21) Appl. No.: 18/257,757

(22) PCT Filed: Dec. 17, 2021
(86) PCT No.: PCT/US2021/064061

§ 371 Date: Jun. 16, 2023

Related U.S. Application Data
(60) Provisional application No. 63/126,965, filed on Dec. 17, 2020.

(51) Int. Cl. G06Q 40/08; H04L 9/32

(52) U.S. Cl. CPC G06Q 40/08; H04L 9/3263

(57) ABSTRACT

In one aspect, an example method includes (a) receiving, by a first computing device of a computing system for verifying an insurance policy, a digital certificate containing insurance policy details associated with an insurance policy; (b) receiving, by a second computing device of the computing system, from the first computing device, the digital certificate; (c) validating, by the second computing device, the digital certificate; and (d) verifying, by the second computing device, via a blockchain network, that the digital certificate has not been revoked, wherein the blockchain network contains a revocation list associated with the insurance company.

### CROSS-REFERENCE TO RELATED APPLICATIONS

This application claims the benefit of priority of U.S. Provisional Patent Application No. 63/126,965, filed Dec. 17, 2020, which is incorporated herein by reference in its entirety.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, an example method is disclosed. The method includes (a) receiving, by a first computing device of a computing system for verifying an insurance policy, a digital certificate containing insurance policy details associated with an insurance policy, wherein the digital certificate is associated with an insurance company; (b) receiving, by a second computing device of the computing system, from the first computing device, the digital certificate; (c) validating, by the second computing device, the digital certificate; and (d) verifying, by the second computing device, via a blockchain network, that the digital certificate has not been revoked, wherein the blockchain network contains a revocation list associated with the insurance company.

In another aspect, an example computing system for verifying an insurance policy is disclosed. The example computing system comprises a first computing device, wherein the first computing device comprises a processor and a non-transitory computer-readable medium, having stored thereon program instructions that, upon execution by the processor, cause the first computing device to perform a set of operations comprising: (a) receiving a digital certificate containing insurance policy details associated with an insurance policy, wherein the digital certificate is associated with an insurance company. The example computing system further comprises a second computing device, wherein the second computing device comprises a processor and a non-transitory computer-readable medium, having stored thereon program instructions that, upon execution by the processor, cause the second computing device to perform a set of operations comprising: (a) receiving, from the first computing device, the digital certificate; (b) validating the digital certificate; and (c) verifying, via a blockchain network, that the digital certificate has not been revoked, wherein the blockchain network contains a revocation list associated with the insurance company.

### BRIEF DESCRIPTION OF THE DRAWINGS

FIG. 1 is a simplified block diagram of an example computing device.

FIG. 2 is a simplified block diagram of an example computing system for verifying an insurance policy.

FIG. 3 is a flow chart of an example method.

FIG. 4 is a simplified block diagram of an example computing system for verifying a digital certificate.

FIG. 5 is a flow chart of an example method.

### DETAILED DESCRIPTION

### I. Overview

Insurance companies routinely evaluate requests for performance arising under previous, existing, or potential insurance policies. These insurance customers may also have to provide proof of their insurance policies to various entities, under a number of conditions, including, for example, (i) a homeowner having to show proof of home insurance to the mortgage company to ensure their mortgage is in good standing, (ii) residential and/or commercial renters having to show proof of renter's insurance to their landlords as part of their rental requirements (iii) automotive insurance holders have to demonstrate proof of insurance to a law enforcement officer at a traffic stop, (iv) drivers for ride-sharing companies have to share their automotive insurance policy evidence with their respective ride-sharing companies, (v) parties leasing cars have to show evidence of auto insurance to their car financing companies.

Conventionally, providing evidence of insurance has been done by sharing a physical insurance policy card (or copy thereof) and/or some digital version of insurance policy papers (e.g., a PDF of an insurance policy card). But, this process is prone to issues like fraud and forgery by the policyholder (e.g., higher limits, longer terms, etc.), a party who is not a policyholder, or other parties that make false representations about an insurance policy allegedly associated with an insurance company. By relying on these conventional methods, the policyholder and/or third parties cannot verify in real-time whether the insurance policy has changed or been cancelled altogether. Physical insurance cards can also be lost and replacement can take time, which can also disrupt the verification process.

If, however, the insurance company could provide an efficient, effective, and novel solution for sharing and verifying evidence of insurance leveraging one or more digital technologies (e.g., blockchain and/or digital certificate technologies), then the overall risk associated with performing based on incorrect policy information would be reduced, as would the risk to third parties who might rely on these false insurance policy representations (e.g., landlords, law enforcement agencies, etc.). Put another way, the more securely and accurately potentially problematic insurance policy information could be detected by the insurance company, the third party, or both, the more advantages all parties could realize.

Accordingly, features of the present disclosure can help to address these and other issues to provide an improvement to select technical fields. More specifically, features of the present disclosure help address issues within and provide improvements for select technical fields, which include for example, computer-based systems for issuing, cancelling, reinstating, and verifying insurance policies, computing devices, applications, and graphical user interfaces (GUIs) used by insurance customers and policyholders, law enforcement agencies, property management systems, mortgage agencies, ride-sharing services, and other similar businesses. Additionally, although the features of the present disclosure primarily address improvements to example embodiments involving the insurance industry, examples of the present disclosure may be used to help address issues within and provide improvements for other industries as well. These features will now be described.

Embodiments of the present invention provide methods, systems, and devices that allow insurance companies to effectively analyze and verify evidence of insurance policies for policyholders and third-parties by leveraging one or more digital technologies (e.g., blockchain and/or digital certificate technologies).

More specifically, example embodiments relate to methods, systems, and devices for improving such evaluation and verification of evidence of insurance by verifying digital information associated with an insurance policy and performing further analysis and verification to ensure that the insurance policy information is as accurate as possible. In a further aspect, this security and accuracy of insurance policy analysis and verification improves third parties' and the insurance company's abilities to mitigate risks of problematic insurance policy information and representations by a policy holder, non-policy holder, or both—an advantageous result for the insurance company, the policyholder, and third parties, alike.

A computing system for verifying an insurance policy may include a first computing device (e.g., a smartphone associated with an insurance customer and/or policyholder) and a second computing device communication device (e.g., a smartphone associated with a third party). These computing devices can be used to perform various operational functions within the computing system to analyze and verify the validity of an insurance policy.

For example, an insurance company may issue evidence of insurance (“EoI”) associated with an insurance policy. This EoI may include a digital certificate associated with an insurance policy, among other possibilities. The digital certificate may also contain insurance policy details associated with an insurance policy, which may also serve as evidence of a valid insurance policy (e.g., the digital certificate may be signed with one or more secure keys and/or signatures associated with the insurance company).

The first computing device (e.g., a smartphone associated with a policyholder) may receive the digital certificate and may do so from a number of sources. For example, the first computing device may receive the digital certificate from a computing device belonging to or associated with the insurance company (e.g., a server and/or database associated with the insurance company). For example, the digital certificate may contain details about an insurance policy, including the: (i) policy status (e.g., whether the policy is active, expired, cancelled, and/or reinstated); (ii) policy start date, term, and/or end date; (iii) policy identification (ID) information (e.g., policy number); (iv) details about the party insured under the policy (e.g., name, address, date of birth, phone number); (v) details about the property insured under the policy (e.g., year, make, model, and/or vehicle identification number (VIN) of covered vehicles, address of a covered residential and/or commercial property); (vi) details about the insurance company issuing the policy (e.g., name, address, phone number); (vii) policy coverage and/or limits; and/or (viii) other information associated with the insurance policy, all of which may be held in one or more fields (e.g., Policy Field 1 . . . Policy Field N). Other examples are possible.

The digital certificate may be signed or associated with one or more security measures that ensure the policy is actually associated with and/or issued on behalf of the insurance company (e.g., security keys and/or one or more secure signatures signed and/or dated by the insurance company). In a further aspect, the insurance company issuing the digital certificate to its policyholders may also maintain this information (e.g., a public and/or private security key pair), and may take different security measures depending on the confidentiality and/or types of the associated information. For example, a public key associated with a digital certificate and/or the insurance company may be publically available, while private key may be securely stored and used for digitally signing the digital certificate on behalf of the insurance company. In another aspect, the digital certificate may also be signed by another party (e.g., a third-party certificate authority), which may also obviate the need for publishing the public key of the insurance company.

In order to take various actions in connection with this insurance policy and/or digital certificate (e.g., issuing, verifying, revoking, and/or reinstating the insurance policy and/or digital certificate), the insurance company may use one or more different technologies.

For example, the insurance company may implement a mobile application executing on a computing device to take various actions in connection with this insurance policy, digital certificate, or both. This mobile application may be used by the insurance customers, third parties (e.g., law enforcement officers), and/or other parties. This mobile application may be used to store and/or retrieve the digital certificate (e.g., from one or more servers associated with the insurance company) and/or take further actions in connection with the digital certificate.

For example, the mobile application can store, retrieve, display, and/or take other actions using policy information associated with the digital certificate and/or insurance policy (e.g., the policy start date, the policy expiration date, and/or policy identification (ID) information). The mobile application may also store, retrieve, generate, and/or display graphical representations of the digital certificate, the insurance policy, or both. For example, the mobile application may generate and display a Quick Response (QR) code that, when scanned, causes retrieval and/or display of policy information (e.g., by directing a computing device to navigate to the URL of a webpage storing the digital certificate). Additionally or alternatively, if a policyholder maintains a physical insurance card, the physical card may also have a QR code that, when scanned, may direct a computing device to the URL of a webpage storing the digital certificate.

In other examples, the digital certificate may also be shared with a second computing device. The second computing device may also execute a mobile application associated with the insurance company. Additionally or alternatively, the second computing device may receive the digital certificate in the manner described above (e.g., by scanning a QR displayed on a first computing device and navigating to the URL of a webpage storing the digital certificate), among other possibilities. For example, the second computing device may receive policy information associated with an insurance (e.g., policy number, policyholder information, etc.) and retrieve the digital certificate from one or more servers associated with the insurance company by using a mobile application associated with the insurance company.

This application may also be used by a computing device (e.g., a third-party computing device) to ensure that the digital certificate is valid. For example, the insurance company may take steps using its computing systems (e.g., one or more servers and mobile applications executing on computing devices) to ensure that if anyone modifies the contents of the digital certificate, the digital validation efforts by the insurance company, a third party, or other parties, would fail. For example, if a party wants to verify the validity of a policy representation from a policyholder, the party could request a digital certificate associated with the alleged policy and then verify the validity of that digital certificate (and, in turn, the insurance policy itself) by using the mobile application associated with the insurance policy. To do so, the mobile application may use one or more validation routines, using one or more components of the insurance company's computing systems.

The second computing device may also validate the digital certificate using services and/or technologies that are independent of the insurance company. For example, the second computing device may verify the validity of the digital certificate using one or more third-party services and/or applications (e.g., a third-party service that validates one or more digital signatures associated with the digital certificate).

Once the digital certificate is validated, the insurance company, a third party, or both may want to take additional steps to further ensure and verify that the digital certificate is valid and/or has not been revoked by the policyholder, the insurance company, or both. One way the insurance company can ensure that these secondary verification efforts are successful may be to maintain information at a site that is separate from the insurance company's computing system. For example, the insurance company may maintain this information on one or more public and/or private blockchain networks.

For example, the insurance company may maintain a list of all revoked insurance policies on a public blockchain network for insurance policies (e.g., insurance policies canceled before their expiration date). To ensure that no confidential customer information is publically disclosed in this revocation list, the insurance company may take one or more steps to anonymize customer information, while also maintaining its ability to verify information that is connected to one or more insurance policy. For example, instead of posting all of the details of an insurance policy on a public blockchain network and/or website, the insurance company can create a unique identifier of the policy and/or digital certificate that contains the requisite information for the policy (e.g., whether it has been revoked and/or when it was revoked) without revealing any other information about the policy (e.g., the policyholder's information). The insurance company may also generate and maintain one or more resources to interpret this anonymized information (e.g., one or more tables of information securely stored on a server and/or database associated with the insurance company, all of which may be accessed by a mobile application associated with the insurance company).

In some examples, the insurance company may do this by creating one or more hash value containing a unique set of characters that are associated with a particular revoked insurance policy. In a further aspect, the insurance company may maintain a list of these hash values (e.g., in a hash index), which may be uploaded to one or more blockchain networks, and may be searched by the insurance company, a third party, a customer, or other parties by a number of means (e.g., a mobile application associated with the insurance company). In a further aspect, to verify that the insurance policy has not been revoked and/or a digital certificate associated with the insurance is valid, a party, using a mobile application on a computing device, may verify to that no hash value in the hash index is associated with the insurance policy and/or digital certificate in question. By creating and searching these hash values using blockchain services, the insurance company also avoids the time and expense of building and maintaining private databases on one or more blockchain networks and/or more costly uploading measures (e.g., uploading the digital certificate itself to a blockchain network, which may be very costly). Other examples are possible.

For example, instead of or in addition to creating these hash values, the insurance company may use blockchain transaction technologies and protocols to verify that an insurance policy and/or digital certificate are valid. For example, the insurance company may use a blockchain service to generate a blockchain account address that is associated with a particular insurance policy and/or digital certificate. Once this account address is generated, the insurance company may post one or more zero-value transactions to the account address associated with a particular insurance policy and/or digital certificate that represent one or more events that occur in connection with the particular insurance policy, digital certificate, or both. For example, if the particular insurance policy and/or digital certificate is revoked, then the insurance company may post a zero-value transaction to the account address associated with the particular insurance policy and/or digital certificate that represents a revocation of the insurance policy. Then, if the particular insurance policy and/or digital certificate is reinstated, then the insurance company may post another zero-value transaction to the account address associated with the particular insurance policy and/or digital certificate that represents a reinstatement of the insurance policy, and so on.

In any event, the insurance company may maintain a list of these blockchain accounts (e.g., in a blockchain account index), which may be searched by the insurance company, a third party, a customer, or other parties by a number of means (e.g., a mobile application associated with the insurance company). In a further aspect, this list may also be searched to lookup various transaction histories detailing zero-value transactions representing one or more policy actions associated with a particular insurance policy (e.g., cancellation, revocation, reinstatement, and/or other events in connection with a particular insurance policy, digital certificate, or both). And, like the hash values and hash index, by maintaining the list of these blockchain transactional accounts using a blockchain service, the insurance company may only update the transaction history of a blockchain address based on actions taken in connection with an insurance policy, while also avoiding the time and expense of building and maintaining private databases on one or more blockchain networks and/or more costly measures—and protecting policyholder information. Other example embodiments are possible.

To facilitate this validation and/or verification process, the insurance company may use one or more applications executing on one or more computing devices. For example, the insurance company may use one or more applications executing on a computing device using the following example source code:

```
If Signature_Valid(EoI_Digital_Certificate) then
  If Expiry_Date(EoI_Digital_Certificate) > Today_Date then
    Revocation_Record=Lookup_Revocation_Record(PolicyId(EoI_Digital_Certifica
    te))
    If Recovation_Record !=NULL then
      IfExpiry_Date(Revocation_Record)>Policy_Start_Date(EoI_Digital_Certi
    ficate) then
        Declare(“Policy Invalid”)
      Else
        Declare(“Policy Valid”)
    Else
      Declare(“Policy Valid”)
  Else
    Declare(“Policy Invalid”)
Else
```

Declare(“Policy Invalid”)

Furthermore, various aspects of this example source code may use one or more of the processes and details described herein (e.g., the “Lookup_Revocation_Record” routine above may be implemented by looking through the transactions posted on the blockchain address used for the revocation list described above).

In another aspect, although various aspects of this disclosure have focused on the insurance company issuing the insurance policy and/or digital certificates described above, other insurance companies may also have access to the revocation and other transactional information, and may also have their own separate publicly known blockchain addresses that they may use to post policy transactions on blockchain services as well.

Other example embodiments are also possible, many of which are discussed in further detail below.

### II. Example Architecture

A. Computing Device

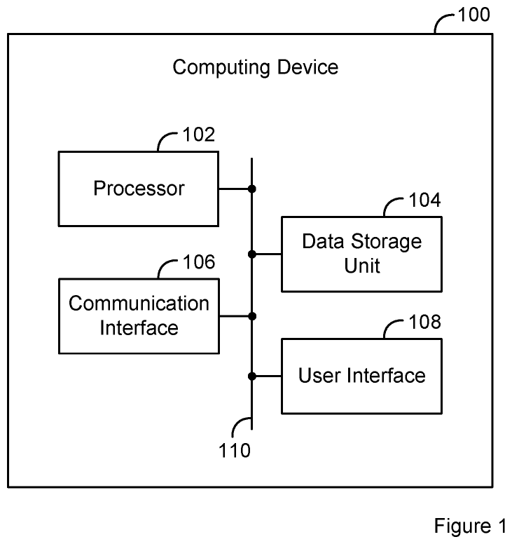

FIG. 1 is a simplified block diagram of an example computing device 100. The computing device 100 can be configured to perform and/or can perform one or more acts and/or functions, such as those described in this disclosure. The computing device 100 can include various components, such as a processor 102, a data storage unit 104, a communication interface 106, and/or a user interface 108. Each of these components can be connected to each other via a connection mechanism 110.

In this disclosure, the term “connection mechanism” means a mechanism that facilitates communication between two or more components, devices, systems, or other entities. A connection mechanism can be a relatively simple mechanism, such as a cable or system bus, or a relatively complex mechanism, such as a packet-based communication network (e.g., the Internet). In some instances, a connection mechanism can include a non-tangible medium (e.g., in the case where the connection is wireless).

The processor 102 can include a general-purpose processor (e.g., a microprocessor) and/or a special-purpose processor (e.g., a digital signal processor (DSP)). The processor 102 can execute program instructions included in the data storage unit 104 as discussed below.

The data storage unit 104 can include one or more volatile, non-volatile, removable, and/or non-removable storage components, such as magnetic, optical, and/or flash storage, and/or can be integrated in whole or in part with the processor 102. Further, the data storage unit 104 can take the form of a non-transitory computer-readable storage medium, having stored thereon program instructions (e.g., compiled or non-compiled program logic and/or machine code) that, upon execution by the processor 102, cause the computing device 100 to perform one or more acts and/or functions, such as those described in this disclosure. These program instructions can define, and/or be part of, a discrete software application. In some instances, the computing device 100 can execute program instructions in response to receiving an input, such as an input received via the communication interface 106 and/or the user interface 108. The data storage unit 104 can also store other types of data, such as those types described in this disclosure.

The communication interface 106 can allow the computing device 100 to connect with and/or communicate with another entity according to one or more protocols. In one example, the communication interface 106 can be a wired interface, such as an Ethernet interface. In another example, the communication interface 106 can be a wireless interface, such as a cellular or WI-FI interface. In this disclosure, a connection can be a direct connection or an indirect connection, the latter being a connection that passes through and/or traverses one or more entities, such as a router, switcher, or other network device. Likewise, in this disclosure, a transmission can be a direct transmission or an indirect transmission.

The user interface 108 can include hardware and/or software components that facilitate interaction between the computing device 100 and a user of the computing device 100, if applicable. As such, the user interface 108 can include input components such as a keyboard, a keypad, a mouse, a touch-sensitive panel, and/or a microphone, and/or output components such as a display device (which, for example, can be combined with a touch-sensitive panel), a sound speaker, and/or a haptic feedback system.

The computing device 100 can take various forms, such as a workstation terminal, a desktop computer, a laptop, a tablet, a mobile phone, and/or a mobile computing device.

B. Insurance Policy Verification System

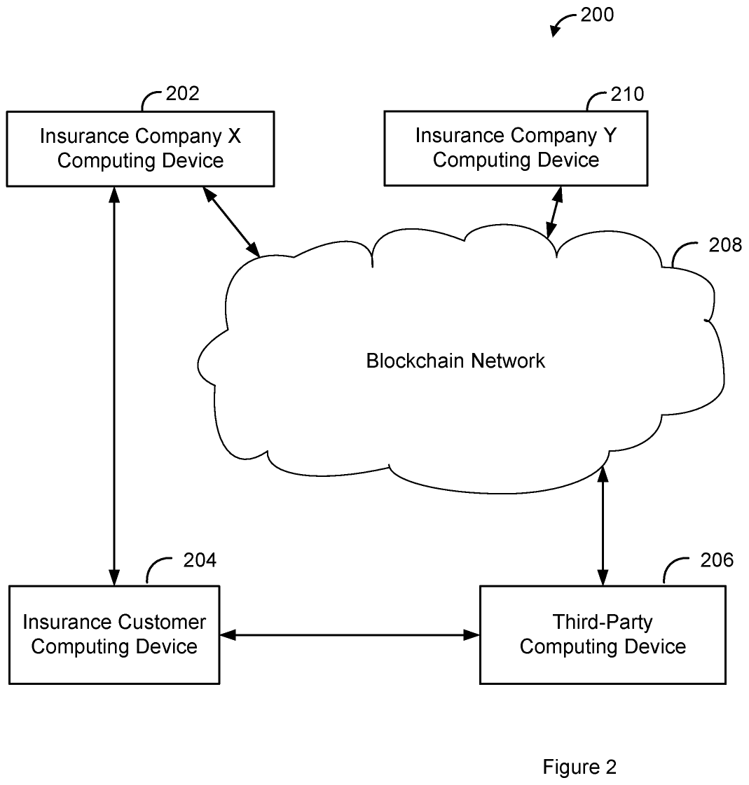

FIG. 2 is a simplified block diagram of an example insurance policy verification computing system 200. The insurance policy verification system 200 can perform various acts and/or functions related to verifying an insurance policy, a digital certificate, and/or both, and can be implemented as a computing system. In this disclosure, the term “computing system” means a system that includes at least one computing device. In some instances, a computing system can include one or more other computing systems, including one or more computing systems controlled by the insurance company, different independent entities, and/or both.

It should also be readily understood that computing device 100, insurance policy verification system 200, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, the insurance policy verification system 200 can include various components, such as Insurance Company X computing device 202, insurance customer computing device 204, third-party computing device 206, blockchain network 208, and Insurance Company Y computing device 210, each of which can be implemented as a computing system.

The insurance policy verification system 200 can also include connection mechanisms (shown here as lines with arrows at each end (i.e., “double arrows”), which connects Insurance Company X computing device 202, insurance customer computing device 204, third-party computing device 206, blockchain network 208, and Insurance Company Y computing device 210, and may do so in a number of ways (e.g., a wired mechanism, wireless mechanisms and communication protocols, etc.).

In practice, the insurance policy verification system 200 is likely to include many or some of all of the example components described above, such as the such as Insurance Company X computing device 202, insurance customer computing device 204, third-party computing device 206, blockchain network 208, and Insurance Company Y computing device 210, which can allow many policyholders to communicate and interact with the insurance company and/or third-parties, many third parties to communicate and interact with the insurance company and/or the insurance customer, and so on.

### IV. Example Operations

The insurance policy verification system 200 and/or components thereof can perform various acts and/or functions (many of which are described above). Examples of these and related features will now be described in further detail.

Within the policy verification system 200, an insurance customer may purchase an insurance policy using a mobile application executing on insurance customer computing device 204 and communicating with Insurance Company X computing device 202.

In one example, Insurance Company X computing device 202 can then issue an insurance policy and a digital certificate representing the purchased insurance policy, both of which may contain various policy details and information, as well as a digital signature or other security measure of the insurance company issuing the policy. Insurance Company X computing device 202 can then send the insurance policy and/or digital certificate to insurance customer computing device 204.

Once insurance customer computing device 204 receives the insurance policy and/or digital certificate, the insurance customer may be asked to produce proof of the issued insurance policy (e.g., by a law enforcement agent during a routine traffic stop). To do so, insurance customer computing device 204 may display the information associated with the insurance policy, the digital certificate, or both. In a further aspect, insurance customer computing device 204 may also display a graphical representation of the issued policy, the digital certificate, or both.

In one example, insurance customer computing device 204 may generate and display a QR code that may be scanned by another computing device. For example, this QR code displayed on insurance customer computing device 204 may be scanned by third-party computing device 206. Once scanned by third-party computing device 206, the third-party computing device 206 may navigate to a URL containing the issued policy and/or digital certificate. In another example, the third-party computing device 206 may also be executing a mobile application associated with the insurance company and once the third-party computing device 206 receives the issued policy and/or digital certificate, the third-party computing device 206 may determine that the issued policy and/or digital certificate is valid using mobile application associated with the insurance company. In other examples, the second computing device may validate the digital certificate without involving the insurance company and/or any application maintained by the insurance company (e.g., the second computing device may validate the digital certificate by using a third-party service), thereby removing any need to reach out to and/or involve the insurance company.

As described in further detail above, Insurance Company X may also maintain one or more sources of information outside of its computing systems and/or mobile applications, for example on blockchain network 208, which may be public or private and may be a physical server, cloud-based server (as illustrated), or some combination thereof. Either way, Insurance Company X may maintain a list of revoked insurance policies (i.e., a revocation list), on blockchain network 208. In a further aspect, the third-party computing device 206 may also verify that the issued policy and/or digital certificate are valid by verifying (e.g., by using a mobile application associated with the insurance company) that the issued policy and/or digital certificate are not included on the list of revoked insurance policies maintained by Insurance Company X on blockchain network 208.

Either way, Insurance Company X may update this list of revoked insurance policies using Insurance Company X computing device 202 and blockchain network 208, which also may be accessed by Insurance Company Y computing device 210, third-party computing device 206, or both, among other possibilities. In any event, in these example embodiments, very little data and/or information can be stored on blockchain network 208, at least, because the issued policy and/or digital certificate are not themselves are not stored on blockchain network 208, and the total data, information, and cost of maintaining the revocation list on blockchain network 208 are low. Various other iterations and advantages are possible as well.

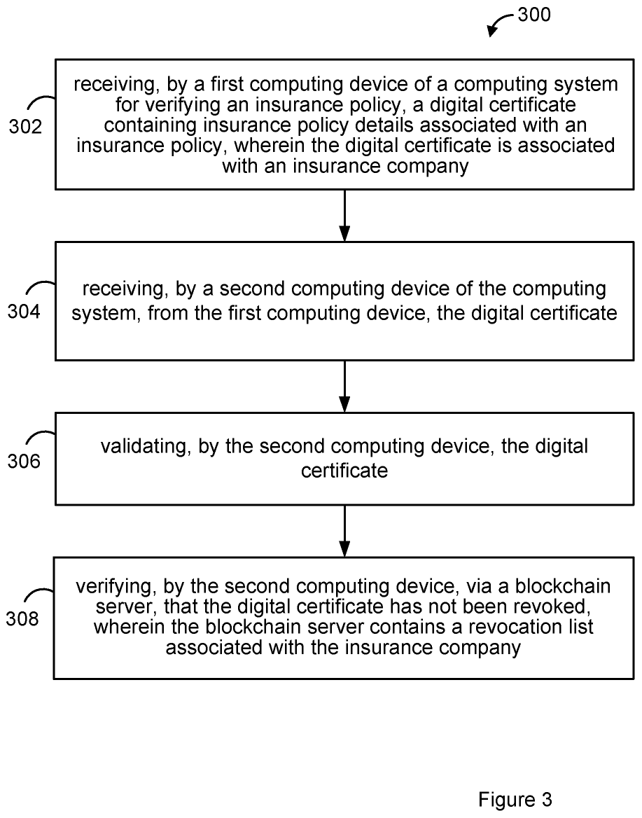

For example, FIG. 3 is a flow chart illustrating an example method 300.

At block 302, the method 300 can include, receiving, by a first computing device of a computing system for verifying an insurance policy, a digital certificate containing insurance policy details associated with an insurance policy, wherein the digital certificate is associated with an insurance company.

At block 304, the method 300 can include, receiving, by a second computing device of the computing system, from the first computing device, the digital certificate.

In some examples, receiving, by a second computing device of the computing system, from the first computing device, the digital certificate includes receiving, by the second computing device of the computing system, from the first computing device, policy information associated with the digital certificate. In other examples, the policy information associated with the digital certificate includes one or more of (i) policy start date, (ii) policy expiration date, or (iii) policy identification (ID) information.

In some examples, receiving, from the first computing device, the digital certificate includes scanning, by the second computing device, a Quick Response (QR) code associated with the digital certificate displayed on the first computing device.

At block 306, the method 300 can include, validating, by the second computing device, the digital certificate.

At block 308, the method 300 can also include, verifying, by the second computing device, via a blockchain network, that the digital certificate has not been revoked, wherein the blockchain network contains a revocation list associated with the insurance company.

In some examples, the blockchain network is a public blockchain network. In other examples, the blockchain network is a private blockchain network.

In still other examples, the revocation list includes a hash index, wherein the hash index contains one or more hash values, and wherein each hash value is a unique set of characters and is associated with a particular revoked insurance policy. In other examples, verifying that the digital certificate has not been revoked includes verifying that no hash value in the hash index is associated with the insurance policy.

In other examples, the revocation list includes a blockchain account index, wherein the blockchain account index contains one or more blockchain account addresses, and wherein blockchain account address is associated with a transaction history detailing zero-value transactions representing one or more policy actions associated with a particular insurance policy.

In some examples, the one or more policy actions associated with a particular insurance policy includes cancelling the particular insurance policy. In other examples, verifying that the digital certificate has not been revoked includes verifying that the zero-value transactions representing cancelling the particular insurance policy does not include any zero-value transactions representing cancelling the insurance policy.

In some examples, the one or more policy actions associated with a particular insurance policy includes reinstating the particular insurance policy. In other examples, verifying that the digital certificate has not been revoked, comprises verifying that the zero-value transactions representing reinstating the particular insurance policy includes zero-value transactions representing reinstating the insurance policy.

C. Digital Certificate Verification System

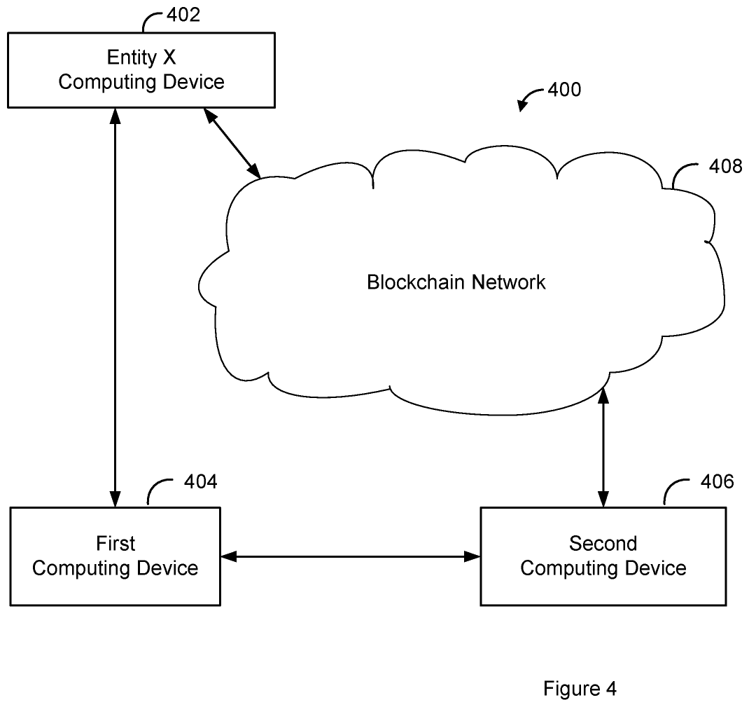

FIG. 4 is a simplified block diagram of an example digital certificate verification computing system 400. The digital certificate verification system 400 can perform various acts and/or functions related to verifying a digital certificate, one or more documents or entity details associated with the digital certificate, and/or both, and can be implemented as a computing system. In this disclosure, the term “computing system” means a system that includes at least one computing device. In some instances, a computing system can include one or more other computing systems, including one or more computing systems controlled by one or more companies, parties, entities, and the like.

It should also be readily understood that computing device 100, digital certificate verification system 400, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, the digital certificate verification system 400 can include various components, such as Entity X computing device 402, first computing device 404, second computing device 406, and blockchain network 408, each of which can be implemented as a computing system.

The digital certificate verification system 400 can also include connection mechanisms (shown here as lines with arrows at each end (i.e., “double arrows”), which connect Entity X computing device 402, first computing device 404, second computing device 406, and blockchain network 408, and may do so in a number of ways (e.g., a wired mechanism, wireless mechanisms and communication protocols, etc.).

In practice, the digital certificate verification system 400 is likely to include many or some of all of the example components described above, such as the such as Entity X, first computing device 404, second computing device 406, and blockchain network 408, which can allow many entities (e.g., companies, one or more persons, and the like, including those associated with first computing device 404 and/or second computing device 406) to communicate and interact with the Entity X and/or other entities and/or third-parties, many other entities (e.g., companies, one or more persons, and the like, including those associated with first computing device 404 and/or second computing device 406) and/or third-parties to communicate and interact with Entity X and/or each other, and so on. In example embodiments, Entity X may comprise one or more entities (e.g., one or more companies, one or more persons, and the like).

### IV. Example Operations

The digital certificate verification system 400 and/or components thereof can perform various acts and/or functions (many of which are described above). Examples of these and related features will now be described in further detail.

Within digital certificate verification system 400, a user of first computing device 404 may purchase, download, or otherwise be associated with a document and/or data structure using a mobile application executing on first computing device 404 and communicating with Entity X computing device 402. These types of documents and/or data structures may include, for example, a document and/or data structures containing personal information.

In some examples, this personal information may include personal information associated with one or more users of the first computing device 404, including employment records (e.g., employment status), health records (e.g., vaccination status and/or details associated therewith), property records (e.g., valid mortgages and/or property deeds), citizenship/residency records (e.g., valid social security card), financial information (e.g., credit scores, available lines of credit and amounts of credit associated therewith, etc.), agency records (e.g., Transportation Security Administration records, arrest records, and the like), information communicated to government entities (e.g., corporate information, including reports to the Federal Insurance Office, Internal Revenue Service, U.S. Department of the Treasury, tax records), information exchanged between entities (e.g., confidential information used in a contract between two companies), and/or other personal information, some or all of which may contain personal identifiable information (PII). In a further aspect, in example embodiments, this personal information may be used in digital certificate verification system 400 to validate a qualifying personal attribute about the user of first computing device 404 (e.g., to confirm vaccination status).

In some examples, this personal information may include information associated with the first computing device 404, itself, including device validation and/or security records (e.g., whether the first computing device 404 has credentials to communicate with a secured network and/or one or more secure devices), and/or other personal information, some or all of which may contain personal identifiable information (PII). In a further aspect, in example embodiments, this personal information may be used in digital certificate verification system 400 to validate a qualifying attribute about the first computing device 404. Other examples are possible.

In one example, Entity X computing device 402 can then issue a digital certificate and documents and/or data structures, any of which may contain various details and information (such as the personal information described above), as well as a digital signature or other security measure of the company issuing the digital certificate and documents and/or data structures associated with the digital certificate. Entity X computing device 402 can then send the digital certificate and documents and/or data structures to first computing device 404.

Once first computing device 404 receives the digital certificate and documents and/or data structures, the user of computing device 404 may be asked to produce proof of the digital certificate and documents and/or data structures associated with the digital certificate (e.g., by an employer of the user of first computing device 404). To do so, first computing device 404 may display the information associated with the digital certificate and documents and/or data structures associated with the digital certificate. In a further aspect, first computing device 404 may also display a graphical representation of the digital certificate and documents and/or data structures, or both.

In one example, first computing device 404 may generate and display a QR code that may be scanned by another computing device. For example, this QR code displayed on first computing device 404 may be scanned by second computing device 406. Once scanned by second computing device 406, the second computing device 406 may navigate to a URL containing the issued digital certificate and documents and/or data structures. In another example, the second computing device 406 may also be executing a mobile application associated with the Entity X and once the second computing device 406 receives the issued digital certificate and documents and/or data structures, the second computing device 406 may determine that the digital certificate and documents and/or data structures is valid using mobile application associated with the Entity X. In other examples, the second computing device may validate the digital certificate without involving the Entity X and/or any application maintained by the Entity X (e.g., the second computing device may validate the digital certificate by using a third-party service), thereby removing any need to reach out to and/or involve the Entity X.

As described in further detail herein, Entity X may also maintain one or more sources of information outside of its computing systems and/or mobile applications, for example on blockchain network 408, which may be public or private and may be a physical blockchain network and/or server, cloud-based server (as illustrated), or some combination thereof. Either way, Entity X may maintain information associated with the digital certificate and documents and/or data structures, including personal information associated with one or more users of the first computing device 404 and/or the device itself, on blockchain network 408. In a further aspect, the second computing device 406 may also verify that the digital certificate and documents and/or data structures are valid by verifying (e.g., by using a mobile application associated with the Entity X) that the the digital certificate and documents and/or data structures are not included on the revocation list maintained by Entity X on blockchain network 408.

Either way, Entity X may update this revocation list using Entity X computing device 402 and blockchain network 408, which also may be accessed by one or more computing devices (including those not illustrated in FIG. 4), second computing device 406, or both, among other possibilities. In any event, in these example embodiments, very little data and/or information can be stored on blockchain network 408, at least, because the digital certificate and documents and/or data structures are not themselves are not stored on blockchain network 408, and the total data, information, and cost of maintaining the revocation list on blockchain network 408 are low. Various other iterations and advantages are possible as well.

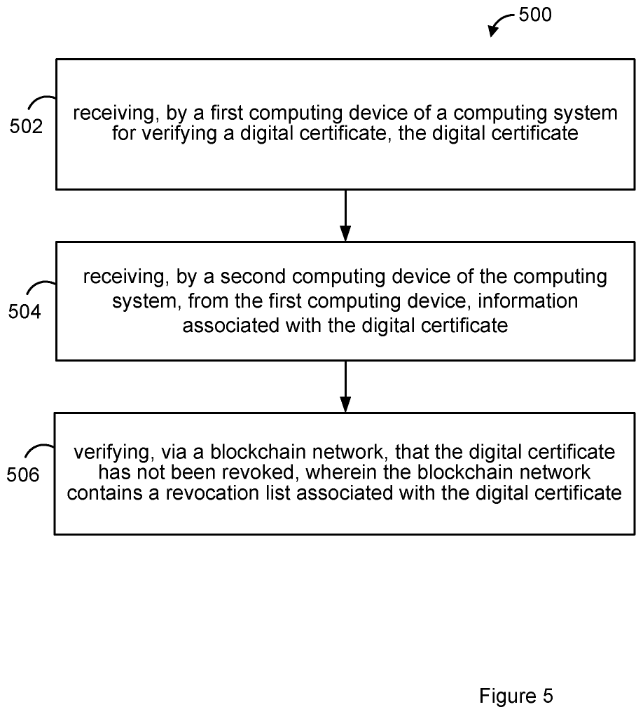

For example, FIG. 5 is a flow chart illustrating an example method 500.

At block 502, the method 500 can include, receiving, by a first computing device of a computing system for verifying a digital certificate, the digital certificate. In some examples, the digital certificate contains details associated with the first computing device. In some examples, the digital certificate contains details associated with a user of the first computing device.

At block 504, the method 500 can include, receiving, by a second computing device of the computing system, from the first computing device, information associated with the digital certificate.

In some examples, receiving, from the first computing device, information associated with the digital certificate comprises scanning, by the second computing device, a Quick Response (QR) code associated with the digital certificate displayed on the first computing device.

At block 506, the method 500 can also include, verifying, by a second computing device of the computing system, via a blockchain network, that the digital certificate has not been revoked, wherein the blockchain network contains a revocation list associated with the digital certificate.

In some examples, the blockchain network is a public blockchain network. In other examples, the blockchain network is a private blockchain network.

In still other examples, the revocation list includes a hash index, wherein the hash index contains one or more hash values, and wherein each hash value is a unique set of characters and is associated with a particular digital certificate. In other examples, verifying that the digital certificate has not been revoked comprises verifying that no hash value in the hash index is associated with the digital certificate.

In other examples, the revocation list includes a blockchain account index, wherein the blockchain account index contains one or more blockchain account addresses, and wherein blockchain account address is associated with a transaction history detailing zero-value transactions representing one or more actions associated with a particular digital certificate.

In some examples, one or more actions associated with a particular digital certificate comprises one or more zero-value transactions indicating that the particular digital certificate is valid. In other examples, verifying that the digital certificate has not been revoked comprises verifying at least one of the one or more zero-value transactions indicating that the particular digital certificate is valid. In some examples, verifying that the digital certificate has not been revoked comprises verifying that the zero-value transactions representing one or more actions associated with a particular digital certificate does not include any zero-value transactions representing that the digital certificate is invalid. In some examples, one or more actions associated with a particular digital certificate comprises one or more zero-value transactions indicating that the particular digital certificate is invalid. In some examples, verifying that the digital certificate has not been revoked comprises verifying at least one of the one or more zero-value transactions indicating that the particular digital certificate is invalid.

In some examples, method 500 further comprises validating, by the second computing device, the digital certificate.

### V. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

We claim:

1. A computing system for verifying an insurance policy comprising:
a first computing device, wherein the first computing device comprises a processor and a non-transitory computer-readable medium, having stored thereon program instructions that, upon execution by the processor, cause the first computing device to perform a set of operations comprising:
receiving a digital certificate containing insurance policy details associated with the insurance policy, wherein the digital certificate is associated with an insurance company; and
a second computing device, wherein the second computing device comprises a processor and a non-transitory computer-readable medium, having stored thereon program instructions that, upon execution by the processor, cause the second computing device to perform a set of operations comprising:
receiving, from the first computing device, the digital certificate;
validating the digital certificate; and
verifying, via a blockchain network, that the digital certificate has not been revoked, wherein the blockchain network contains a revocation list associated with the insurance company.

2. The computing system of claim 1, wherein receiving, from the first computing device, the digital certificate comprises receiving, from the first computing device, by the second computing device, policy information associated with the digital certificate.

3. The computing system of claim 2, wherein policy information associated with the digital certificate comprises one or more of (i) policy start date, (ii) policy expiration date, or (iii) policy identification (ID) information.

4. The computing system of claim 1, wherein receiving, from the first computing device, the digital certificate comprises scanning, by the second computing device, a Quick Response (QR) code associated with the digital certificate displayed on the first computing device.

5. The computing system of claim 1, wherein the blockchain network is a public blockchain network.

6. The computing system of claim 1, wherein the blockchain network is a private blockchain network.

7. The computing system of claim 1, wherein the revocation list comprises a hash index, wherein the hash index contains one or more hash values, and wherein each hash value comprises a unique set of characters and is associated with a particular revoked insurance policy.

8. The computing system of claim 7, wherein verifying that the digital certificate has not been revoked comprises verifying that no hash value in the hash index is associated with the insurance policy.

9. The computing system of claim 1, wherein the revocation list comprises a blockchain account index, wherein the blockchain account index contains one or more blockchain account addresses, and wherein blockchain account address is associated with a transaction history detailing zero-value transactions representing one or more policy actions associated with a particular insurance policy.

10. The computing system of claim 9, wherein one or more policy actions associated with a particular insurance policy comprises cancelling the particular insurance policy.

11. The computing system of claim 10, wherein verifying that the digital certificate has not been revoked comprises verifying that the zero-value transactions representing cancelling the particular insurance policy does not include any zero-value transactions representing cancelling the insurance policy.

12. The computing system of claim 9, wherein one or more policy actions associated with a particular insurance policy comprises reinstating the particular insurance policy.

13. The computing system of claim 12, wherein verifying that the digital certificate has not been revoked comprises verifying that the zero-value transactions representing reinstating the particular insurance policy includes zero-value transactions representing reinstating the insurance policy.

14. A method comprising:
receiving, by a first computing device of a computing system for verifying an insurance policy, a digital certificate containing insurance policy details associated with an insurance policy, wherein the digital certificate is associated with an insurance company;
receiving, by a second computing device of the computing system, from the first computing device, the digital certificate;
validating, by the second computing device, the digital certificate; and
verifying, by the second computing device, via a blockchain network, that the digital certificate has not been revoked, wherein the blockchain network contains a revocation list associated with the insurance company.

15. The method of claim 14, wherein receiving, by a second computing device of the computing system, from the first computing device, the digital certificate comprises receiving, by the second computing device of the computing system, from the first computing device, policy information associated with the digital certificate.

16. The method of claim 15, wherein policy information associated with the digital certificate comprises one or more of (i) policy start date, (ii) policy expiration date, or (iii) policy identification (ID) information.

17. The method of claim 14, wherein receiving, from the first computing device, the digital certificate comprises scanning, by the second computing device, a Quick Response (QR) code associated with the digital certificate displayed on the first computing device.

18. The method of claim 14, wherein the blockchain network is a public blockchain network.

19. The method of claim 14, wherein the blockchain network is a private blockchain network.

20. The method of claim 14, wherein the revocation list comprises a hash index, wherein the hash index contains one or more hash values, and wherein each hash value comprises a unique set of characters and is associated with a particular revoked insurance policy.

21. A computing system for verifying a digital certificate comprising:
a first computing device, wherein the first computing device comprises a processor and a non-transitory computer-readable medium, having stored thereon program instructions that, upon execution by the processor, cause the first computing device to perform a set of operations comprising:
receiving the digital certificate; and
a second computing device, wherein the second computing device comprises a processor and a non-transitory computer-readable medium, having stored thereon program instructions that, upon execution by the processor, cause the second computing device to perform a set of operations comprising:
receiving, from the first computing device, information associated with the digital certificate; and
verifying, via a blockchain network, that the digital certificate has not been revoked, wherein the blockchain network contains a revocation list associated with the digital certificate.

22. The computing system of claim 21, wherein the digital certificate contains details associated with the first computing device.

23. The computing system of claim 21, wherein the digital certificate contains details associated with a user of the first computing device.

24. The computing system of claim 21, wherein receiving, from the first computing device, information associated with the digital certificate comprises scanning, by the second computing device, a Quick Response (QR) code associated with the digital certificate displayed on the first computing device.

25. The computing system of claim 21, wherein the revocation list comprises a hash index, wherein the hash index contains one or more hash values, and wherein each hash value comprises a unique set of characters and is associated with a particular digital certificate.

26. The computing system of claim 25, wherein verifying that the digital certificate has not been revoked comprises verifying that no hash value in the hash index is associated with the digital certificate.

27. The computing system of claim 21, wherein the revocation list comprises a blockchain account index, wherein the blockchain account index contains one or more blockchain account addresses, and wherein blockchain account address is associated with a transaction history detailing zero-value transactions representing one or more actions associated with a particular digital certificate.

28. The computing system of claim 27, wherein one or more actions associated with a particular digital certificate comprises one or more zero-value transactions indicating that the particular digital certificate is valid.

29. The computing system of claim 28, wherein verifying that the digital certificate has not been revoked comprises verifying at least one of the one or more zero-value transactions indicating that the particular digital certificate is valid.

30. The computing system of claim 28, wherein verifying that the digital certificate has not been revoked comprises verifying that the zero-value transactions representing one or more actions associated with a particular digital certificate does not include any zero-value transactions representing that the digital certificate is invalid.

31. The computing system of claim 27, wherein one or more actions associated with a particular digital certificate comprises one or more zero-value transactions indicating that the particular digital certificate is invalid.

32. The computing system of claim 31, wherein verifying that the digital certificate has not been revoked comprises verifying at least one of the one or more zero-value transactions indicating that the particular digital certificate is invalid.

33. The computing system of claim 21, wherein the set of operations further comprises validating, by the second computing device, the digital certificate.
